(19) United States
(12) Patent Application Publication
(10) Pub. No.: US 2026/0180704 A1
(43) Pub. Date: Jun. 25, 2026

(54) Method and System for Time Synchronization of Sensor Units

(71) Applicant: Siemens Aktiengesellschaft, Muenchen (DE)

(72) Inventors: Jaroslaw KUSSYK, Wien (AT); Josef BRANDSTETTER, Wien (AT); Oliver SCHRÖDEL, Erlangen (DE)

(21) Appl. No.: 19/424,638

(22) Filed: Dec. 18, 2025

(30) Foreign Application Priority Data
Dec. 19, 2024 (EP) 24221595

(51) Int. Cl. H04J 3/06; H02J 13/13

(52) U.S. Cl. CPC H04J 3/0638; H02J 13/1331

(57) ABSTRACT

Method for time synchronization of sensor units in a distributed system, wherein a further current value of an internal time unit of a respective sensor unit is stored upon capture of sensor data, the captured sensor data is assigned the value of the internal time unit stored upon receipt of a characteristic time feature of the identification signal, the associated transmitter identification of the identification signal and the further value of the internal time unit stored upon capture of the sensor data, and transmitted together with the sensor data to the central unit, where the central unit captures voltage/phase values from at least one of phase conductor of a power supply network, and the respective sensor unit captures respective sensor data as current values in relation to synchronization data, which is transmitted to the central unit and, the powers are calculated in the central unit from the voltage/current values

### BACKGROUND OF THE INVENTION

### 1. Field of the Invention

The invention relates to a method and a system for the time synchronization of sensor units in a distributed system.

### 2. Description of the Related Art

In electrical power distribution structures, such as intelligent DC and AC distribution networks, “smart grids”, information about a network status, such as voltage level, current load, power flow, and/or load distribution, is captured and determined by many types of distributed sensor data.

In order to monitor and control the grids, sensor data is usually transmitted and evaluated centrally.

Depending on the sensor type and how the sensor data is centrally evaluated, the sensor value and the time of capture are important for evaluation, in order, for example, to enable the calculation of active and reactive power from voltage and current measurements, which can be transmitted by different, potentially locally distributed, sensors.

The exact measurement capture times, particularly their interrelationships, are particularly essential for determining active and reactive power or complex apparent power.

In the prior art, time synchronization was/is achieved by wired communication links between the sensors and the evaluation unit or the measured voltage was supplied as an analog measured value signal to individual current sensors via a wired connection.

A conventional wireless alternative solution is to use an additional time synchronization source for each sensor, which is available via a radio link, for example a GPS clock, a radio time standard transmitter (such as the DCF77 longwave transmitter) or a central network time protocol (NTP) reference time server.

The disadvantage of wired communication solutions is the requirement for a data line which could lead to increased installation costs and lower user acceptance; this can be a relevant cost factor and system complexity factor, particularly when retrofitting sensors.

The disadvantage of radio-based time synchronization sources is the restrictions on the installation position of the antenna. For example, it is very difficult, or even impossible, to receive GPS/DCF77/mobile radio time signals indoors.

In addition, DCF77 or comparable time information services are not sufficiently accurate and are restricted to specific regions.

In addition, such solutions give rise to undesirable system complexity and disadvantageous installation requirements while also resulting in increased costs due to an additional radio receiver and the associated antenna.

EP3993290B1 discloses a method for time synchronization of sensor units of a distributed system via which a temporal relationship can be established between the captured sensor data of the sensor units of the distributed system, but internal signal propagation times are not taken into account during signal capture and this adversely affects the accuracy of the determination of power consumption in a power distribution network.

### SUMMARY OF THE INVENTION

In view of the foregoing, it is therefore an object of the invention to provide a simpler, accurate and reliable solution for synchronizing distributed sensors.

This and other objects and advantages are achieved in accordance with the invention by a method for time synchronization of sensor units in a distributed system, where the sensor units each have an internal time unit, and where sensor data is captured by the sensor units and transmitted to a central unit via a radio network, and where an identification signal is transmitted in the radio network at regular time intervals. The method includes monitoring reception of the identification signal in a respective sensor unit, where, upon receipt of a characteristic time feature of the identification signal, in a current value of the internal time unit of each respective sensor unit is stored with at least one transmitter identification contained in the identification signal, where upon capture of sensor data, a further current value of the internal time unit of the respective sensor unit is stored, where the captured sensor data is assigned at least the value of the internal time unit stored upon receipt of the characteristic time feature of the identification signal, the associated transmitter identification of the identification signal and the further value of the internal time unit stored upon capture of the sensor data and transmitted together with the sensor data to the central unit, where a reference time base is derived based on the transmitter identification and a temporal relationship of the transmitted sensor data of the respective sensor unit to the reference time base is derived based on the value of the internal time unit of the respective sensor unit stored upon receipt of the characteristic time feature of the identification signal and the further value of the internal time unit of the respective sensor unit stored upon capture of the sensor data, where the central unit captures voltage and phase values of at least one of the three phase conductors of a power supply network from which synchronization data for the frequency or period and the phase angle of the voltage of at least one of the three phase conductors in relation to the time of capture of the voltage and phase values of the at least one of the three phase conductors is ascertained and transmitted to the sensor units, and where the respective sensor unit captures the respective sensor data in the form of current values in relation to synchronization data, which sensor data is transmitted to the central unit and, in the central unit, powers are calculated from the voltage values and current values.

This enables synchronous power measurement using radio-based current sensors and a common central voltage capture unit allowing for flexible and efficient retrofitting and expansion of devices for monitoring electrical power distribution networks without increased wiring complexity.

Synchronous measurement of the power of the consumer system enables particularly precise measurement in a simple manner.

It should be understood the calculation of powers in the central unit is thus based on the voltage values and current values taking into account their respective phase angles. This is achieved by measuring the voltages in the power supply network at only one point and capturing the currents at a plurality of distributed points.

In practice, this is less complex than additionally capturing voltages at distributed locations, because this would require enhanced safeguarding measures and would also necessitate solving the overvoltage problem.

In addition, the aforementioned decentralized active and reactive power measurement does not require any additional synchronization source or additional wiring.

Synchronization can, for example, be achieved by matching a time base of a leader timer within the central unit with a corresponding subsequent time base of the respective sensor unit.

The current flowing through the sensor unit can also be used for its power supply, thus allowing for particularly simple retrofitting and low-maintenance integration into an existing system.

The identification signal can, for example, be used to apply a synchronization frame to a message, in particular a message sent to a plurality of recipients (“multicast”).

In at least one or all sensor units, during the current measurement period, synchronized zero-crossing times of the reference voltage are determined in the central unit based on the transmitted values for the zero-point crossing and the period duration and optionally the value for the zero-point crossing in the previous period, and the alternating current values are then used to form current phasors for each individual fundamental-voltage oscillation period within the current measurement period.

In an embodiment of the invention, synchronization data relating to the phase angle of the voltage of at least one of the three phase conductors in relation to the time of capture of the voltage and phase values of the at least one of the three phase conductors is formed by the time of transmission from the central unit to the respective sensor unit. This enables synchronization data for compensating the delay to be ascertained and transmitted in a particularly simple manner.

In another embodiment of the invention, synchronization data is transmitted to the sensor units with the aid of the identification signal. This enables synchronization data for compensating the delay to be transmitted in a particularly simple manner or the time base in the sensor unit to be adjusted.

In a further embodiment of the invention, synchronization data is ascertained over more than one period of the voltage and phase values of the three phases of the power supply network, preferably from at least ten periods, particularly preferably from at least 100 periods. This ensures that the load on the radio channel is reduced and a smaller amount of data is transmitted while still maintaining sufficient accuracy for power measurement in the power supply network.

In another embodiment of the invention, the central unit captures voltage and phase values from a phase conductor of the power supply network and first supplementary synchronization data for the time delay in the transmission of the identification signal that was captured in a previous period prior to the current period in which synchronization data is captured and the first supplementary synchronization data is transmitted to the respective sensor unit, preferably with the aid of the identification signal, and the first supplementary synchronization data is taken into account upon capture of respective sensor data by the respective sensor unit. This enables measuring accuracy to be improved in a simple manner. In addition, synchronization data for compensating the delay can be ascertained and transmitted in a particularly simple manner.

The first supplementary synchronization data is the value of the time delay in the previous measurement cycle.

First, synchronization data in the form of the zero-point crossing times in the central controller and the period in the phase conductor is transmitted. Only then, at the beginning of the next subsequent measurement period, is the captured delay in the transmission of the synchronization frame specified retrospectively.

The aforementioned phase conductor of the power supply network is a selected reference conductor of the three phase conductors and serves as a reference for the phase angles of the further phase conductors.

In another embodiment of the invention, the central unit further includes an internal central time unit, the value of which forms second supplementary synchronization data, and the second supplementary synchronization data is transmitted to the respective sensor unit, preferably with the aid of the identification signal, and the second supplementary synchronization data is taken into account upon capture of the respective sensor data by the respective sensor unit. This enables measuring accuracy to be improved in a simple manner. In addition, synchronization data for compensating the delay can be ascertained and transmitted in a particularly simple manner.

In yet another embodiment of the invention, the current values of the respective sensor unit are aggregated to form aggregated current values, and the aggregated current values are transmitted to the central unit and, in the central unit, powers are calculated from the voltage values and the aggregated current values. This enables the amount of data transmitted from the respective sensor unit to the central unit to be reduced and correspondingly the transmission channel to be used efficiently.

The objects and advantages are also achieved in accordance with the invention by a distributed system for time synchronization of sensor units further comprising a central unit, where the system is configured to execute the method in accordance with the disclosed embodiments of the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be explained in more detail in the following figures on the basis of exemplary embodiments, in which:

FIGS. 1-3 show examples of adjusting the phasing of voltage or current pointers to a reference phase line with the reference voltage thereof;

FIG. 1 an exemplary power distribution network;

FIG. 2 a first block diagram of an exemplary embodiment of the invention in the form of a block diagram,

FIG. 3 a second block diagram of an exemplary embodiment of the invention;

FIG. 4 a third block diagram of an exemplary embodiment of the invention;

FIG. 5 a detailed view of the central unit in accordance with the invention;

FIG. 6 an example of a signal profile in the power distribution network; and

FIG. 7 is a flowchart of the method in accordance with the invention.

### DETAILED DESCRIPTION OF THE EXEMPLARY EMBODIMENTS

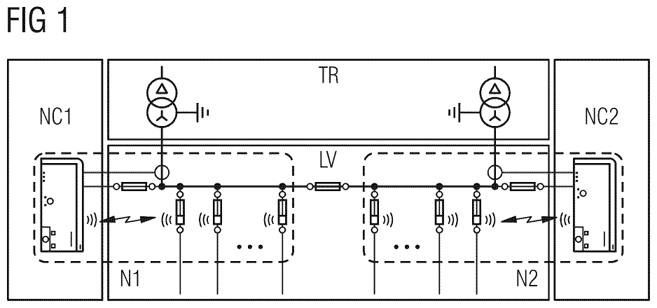

FIG. 1 shows an example of a power distribution network in the form of a “single-line” block diagram.

Herein, the lines represent 3-, 4- or 5-wire connections of individual branches in the low-voltage and medium-voltage area (common designations are L1, L2, L3 or L1, L2, L3, PEN/E or L1, L2, L3, N and PE/E).

A sensor unit and/or a central unit can be installed in each of the listed conductors as well as in the medium-voltage branches/area.

In a “secondary substation”, high voltage is converted into a low voltage range LV with the aid of one or more transformers TR.

Central units are connected to respectively assigned sensor units via respective wireless networks N1, N2 which are controlled via correspondingly assigned network-controllers NC1, NC2.

A sensor unit is used to capture currents in the phase conductors of individual branches to end consumers. In the sensor unit, which is installed as NH fuse sets or, for example, in the medium-voltage lines/branches, current phasors, i.e., complex values for the respective currents, are captured as current values or sensor data, where an average value is optionally formed for the ascertained currents and this is transmitted.

So-called time-synchronized current phasors captured synchronously with voltage phasors at a specific point in time can be used.

The currents used can be the mean values of the current phasors or current values/amplitudes or current RMS values, because the mean values of the alternative currents are often close to zero.

In the central unit, voltage phasors, i.e., complex values for the respective voltages, are captured as voltage values, where a mean value is optionally formed for the ascertained voltages.

So-called time-synchronized voltage phasors captured synchronously with current phasors at a specific time can be used.

The voltages used can be the mean values of the voltage phasors or voltage values/amplitudes or voltage RMS values, because the mean values of the alternating voltages are often close to zero.

In the central unit, the averaged current phasors are received from one or more sensor units via short-range communication (such as “Zigbee” or Bluetooth).

The active and reactive power P and Q in the respective phase lines is calculated in the central unit taking into account the associated averaged voltage phasors.

Phasors for current or voltage should be understood to be respective complex values, i.e., magnitude values and phase values for the current or voltage.

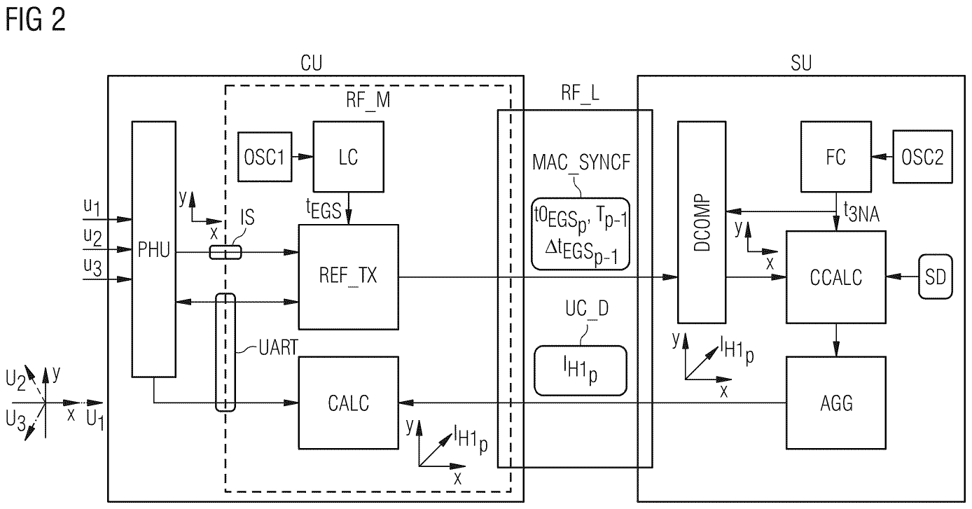

FIG. 2 shows a first block diagram of an exemplary embodiment of the invention.

A central unit CU comprises an apparatus for reference phase transmission PHU, which serves to:
detect a zero crossing of a voltage profile,
calculate voltages with magnitude and phase information, i.e., voltage phasors,
count measurement periods p of a respective reference voltage U_{REF_H1} selected from the mains voltages u1, u2, u3, which are preferably phase voltages,
determine a reference conductors LREF from mains phase conductors L1, L2, L3 of a power supply network,
determine a phase sequence of mains voltages u1, u2, u3 in the form of voltage phasors U1, U2, U3 of the mains voltage.

A measurement period p can be considered to be a period that can also last longer than one mains voltage period, which can also be referred to as fundamental-voltage oscillation periods, which are then counted accordingly.

Fundamental-voltage oscillation is often referred to as the 1st harmonic or “H1” for short, of the mains voltage.

The data from the reference phase transmission PHU apparatus is accordingly distributed to a radio-frequency module RF_M in the central unit CU with the aid of a transmitter or receiver UART, or via an internal interface, such as a serial interface.

An interrupt signal IS for the zero crossing of the reference voltage U_{REF_H1} is provided to a reference signal transmitter REF_TX within the radio-frequency module RF_M, which in turn receives information regarding a time delay Δt_{EGS} from a central oscillator OSC1 and connected leader clock LC.

The time delay Δt_{EGS} at the beginning of a measurement period p is a delay between the time t0_{EGSp} of activation of the interrupt signal IS, i.e., for the zero crossing of the reference voltage U_{REF_H1}, and the time t_{EGS_SYNCp} of transmission of the synchronization frame MAC_SYNCF to the respective sensor unit SU.

The two times t0_{EGSp} and t_{EGS_SYNCp}, and the delay Δt_{EGS} are ascertained in the radio-frequency module RF_M based on the time information t_{EGS} provided by the oscillator OSC1 and a connected leader clock LC.

The synchronization frame MAC_SYNCF provides information about the period Tₚ₋₁, i.e., an estimated current voltage period ascertained based on the last 10 to 30 voltage periods of the previous measurement period p−1, for example, and the time delay Δt_{EGSp-1}, which was ascertained at the beginning of the previous measurement period p−1, but after transmission of the synchronization frame MAC_SYNCF, and the time t0_{EGSp} of activation of the interrupt signal IS, i.e., for the zero crossing of the reference voltage U_{REF_H1}, as a value from the leader clock LC.

The beginning of transmission of the SYNC frame implicitly corresponds to the time t_{EGS_SYNCp}=t0_{EGSp}+Δt_{EGSp}.

In the exemplary embodiment, the information about the time delay Δt_{EGSP} is only generated after the transmission of the synchronization frame MAC_SYNCF and is transmitted with the next synchronization frame MAC_SYNCF at the beginning of the measurement period p+1. Only then, i.e., one measurement cycle later, is it possible to compensate the time delay Δt_{EGSp} for the measurement period p.

The radio-frequency module RF_M also provides a calculator CALC for calculating active and reactive power P and Q from corresponding voltages/voltage phasors and currents/current phasors.

A radio-frequency transmission path RF_L is used for wireless transmission of synchronization information to one or more sensor units SU and transmission of sensor data captured by the sensor units SU to the central unit CU, for example, as a “unicast” data transmission UC_D, as described in more detail below.

The sensor units SU are each local controllers for data capture by corresponding sensor apparatuses.

The radio-frequency transmission path RF_L can transmit a synchronization frame MAC_SYNCF using a MAC layer-based “multicast” of the synchronization frame.

The sensor unit SU has a compensation apparatus DCOMP for the time delay Δt_{RF_L} in the radio-frequency transmission path RF_L and a local oscillator OSC2 and a connected follower clock FC, which provide time information t_{3NA}.

The time delay Δt_{RF_L} also takes into account the time delay in the receiver within the sensor unit SU up to the compensation apparatus DCOMP.

The time t_{3NA} is the local value of the follower clock FC in the local controller, i.e., the sensor unit SU.

In the sensor unit SU, the capture of current phasors is synchronized with the zero crossing of the reference voltage U_{REF_H1} in the central unit CU.

Following compensation of the time delay of the radio-frequency transmission path RF_L in the compensation apparatus DCOMP, the reception times t0_{3NAp} and t0_{3NAp+1} of the synchronization frame MAC_SYNCF at the beginning of the measurement periods p and p+1 correspond to the corresponding transmission times t_{EGS_SYNCp} and t_{EGS_SYNCp+1} in the central unit CU.

Based on the time t0_{EGSp} transmitted at the beginning of the measurement period p and the time t0_{EGSp+1} transmitted at the beginning of the measurement period p+1 and the information about the time delay Δt_{EGSp} and the period Tₚ, the sensor unit SU first estimates the time t0_{EGSp+1} of the zero crossing of the reference voltage U_{REF_H1} as time t0_{EGSp}+1*=t0_{3NAp}+t0_{EGSp}+1−t0_{EGSp}−Δt_{EGSp}, which corresponds to the estimated value from the follower clock FC in the sensor unit SU at time t0_{EGSp+1} in the central unit CU.

Then, the zero-crossing time of the next period of the reference voltage U_{REF_H1} is determined as time t0_{3NAi+101}=t0_{EGSp+1}*+Tₚ.

The times with the index * indicate an estimated value and correspond to the follower clock FC.

The times with the index 3NA correspond to times in the sensor unit SU and are formed by the follower clock FC.

The times with the index EGS correspond to times in the central unit CU and are formed by the leader clock LC.

The actual current measurement or current phasor ascertainment in the measurement period p+1 begins in the sensor unit SU with the time t0_{3NAi+101}.

Sensor data SD is captured by the sensor unit SU as current values I, processed and calculated as current phasor values, and then optionally transferred to an aggregation apparatus AGG for processing.

Sensor data SD can, for example, be alternating current values of the primary current in a power supply network.

Aggregation can, for example, be understood to be averaging over several measured values, such as over several alternating current periods within a measurement period, where other statistical methods can also be suitable for mapping measured values.

The synchronization frame or frame MAC_SYNCF transmits information about its time of transmission in the form of a counter reading difference Δt_{EGSP} to the sensor unit SU by “multicast” transmission, as well as the period Tₚ₋₁ of the voltage profile U_{REF_H1} from the previous period p−1, and the time t0_{EGSp} of activation of the interrupt signals IS, i.e., for the zero crossing of the reference voltage U_{REF_H1}, as value t0_{EGSp} from the leader clock LC.

Information on the captured sensor data SD is transmitted from the sensor unit SU as values for the complex current phasor I_{H1p} for the period with index p, and the current phasors I_{H1p}, as an individual value or as an aggregated value, depending on the embodiment, to the central unit CU by “unicast” transmission.

The central unit CU forms voltage phasors U1ᵢ, U2ᵢ or U3ᵢ for each period i (of the fundamental oscillation) of the mains alternating voltage u₁, u₂, and u₃ of a 3-phase system. Optionally, the voltage phasors can also be aggregated.

The voltages u₁, u₂, and u₃ can, for example, be voltages on phase conductors L₁, L₂, or L₃ of a power supply network. One of the voltages, such as u₁, is selected as a reference voltage U_{REF_H1}.

For each measurement cycle p which, for example, comprises 100 fundamental oscillation periods of the reference voltage U_{REF_H1}, a zero-point crossing time t0_{EGSp} of the reference voltage U_{REF_H1} is determined, which is phase-synchronous with the beginning of the first fundamental oscillation period of the reference voltage U_{REF_H1} and refers to the microsecond counter in the central unit CU in the form of the leader clock LC with the time t_{EGS}.

The zero-point crossing time t0_{EGSp} refers to the current time in the central controller, while the zero-point crossing time t0_{EGSp-1} refers to the first zero-point crossing time of the previous measurement period.

In addition, the current mains voltage period Tₚ is determined.

As additional information, it is optionally also possible to determine the time as a difference counter reading Δt_{EGSP-1} after the values for the counter reading Δt_{EGSP-2} and the period Tₚ₋₂ (not shown in the figure) in the previous measurement period p−1 have been transmitted to the sensor unit SU by means of an identification signal, the so-called SYNC frame MAC_SYNCF.

The time Δt_{EGSP-1} is used to correct the temporal synchronism between the central unit CU and at least one sensor unit SU in the current measurement period p.

In addition to the zero-point crossing time t0_{EGSp}, the period Tₚ and the optional counter reading difference Δt_{EGSP-1}, the synchronization frame or “SYNC frame” MAC_SYNCF, which initiates the beginning of the measurement period p, also contains the number of the measurement period p itself, the number i of the first fundamental oscillation period of the reference voltage U_{REF_H1} in this measurement period and a network source address of the central unit CU, which serves as transmitter identification in the SYNC frame MAC_SYNCF.

The measurement period is established based on a fundamental oscillation period counter, for example, in the form of a time unit.

In at least one, or even all, sensor units SU, in the measurement period p, zero-point crossing times of the reference voltage U_{REF_H1} in the central unit CU are determined synchronously based on the transmitted values for the zero-point crossing times t0_{EGSp} and t0_{EGSp-1} in the central controller CU, the current period Tₚ, and the optional time of deviation of the time delay Δt_{EGSP-1}, where these times correspond to values of the respective leader clock LC.

Sensor data SD in the form of alternating current values is used as the basis for forming the current phasors I_{H1i} for each individual harmonic period i within the measurement period p, and transmitted either individually or as current phasors I_{H1p} aggregated over the measurement period p to the central unit CU in a sensor data frame with sensor data SD.

The same sensor data frame can, for example, also contain the time stamp t_{3NA} of the respective sensor units SU, a number i of the first fundamental oscillation period of the reference voltage U_{REF_H1} in the measurement period p and optionally the numbers of the current measurement period p and/or the previous measurement periods p−1, p−2.

After the sensor data SD has been received in the central unit CU, the associated synchronously captured voltage and current phasors are used to calculate the active and reactive power values Pₚ and Qₚ.

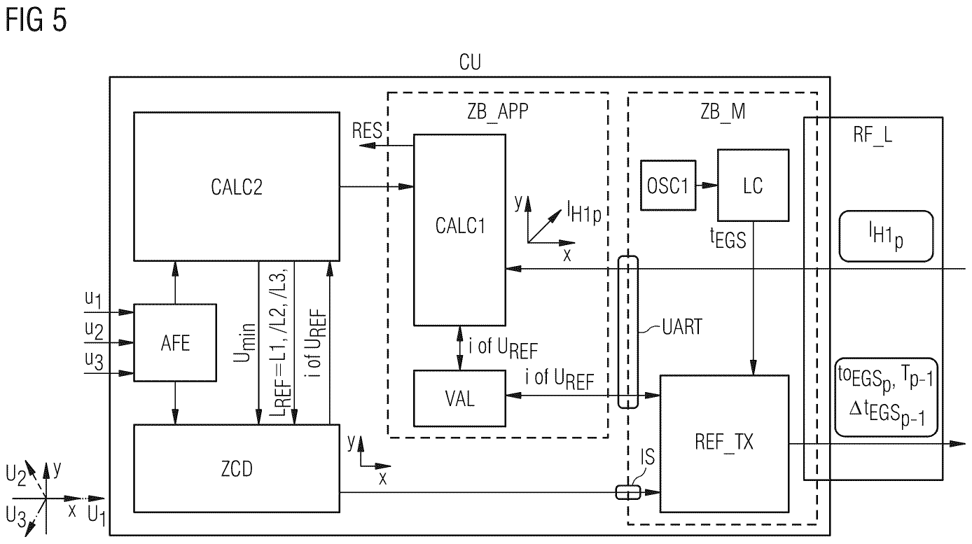

In other words, in the exemplary embodiment in FIG. 5, the transmission time of the SYNC frames MAC_SYNCF is provided as the start of the SYNC frame “header” MAC_SYNCF and additionally as the counter reading (difference) of the clock LC of the central unit CU via the reference signal transmitter REF_TX, preferably corresponding to a time resolution in the microsecond range.

Hence, in the following SYNC frame MAC_SYNCF, the zero-point crossing t0_{EGSp} is transmitted as the start of the synchronization frame MAC_SYNCF and as the current counter reading at the time t0_{EGSp} of the zero-point crossing and the difference of the counter readings Δt_{EGSp-1} between the previous reference zero-point crossing and the previous transmission time.

Hence, in the present exemplary embodiment, the signal propagation time is corrected in the respective sensor unit SU at the beginning of the current measurement period p using the zero-point crossing t0_{EGSp-1} from the previous SYNC frame MAC_SYNCF of the measurement period p−1 and the zero-point crossing t0_{EGSp} from the current measurement period p from the currently received SYNC frame MAC_SYNCF and the transmission delay Δt_{EGSP-1}.

The time delay Δt_{RF_L} can be taken into account in the compensation by the DCOMP, but this is very small and can be disregarded for the sake of clarity.

Therefore, in this case, two consecutive SYNC frames are always necessary to ascertain the zero-point crossing of the reference voltage U_{REF_H1} in the sensor unit SU.

Therefore, the first exemplary embodiment can also be described using the following words.

The method for time synchronization of sensor units in a distributed system is used to determine reactive and active power in the central unit CU with at least one sensor unit SU and is based on synchronization of the zero crossing of the reference voltage between the central unit CU with a sensor unit SU, i.e., between the first leader clock LC with a first central oscillator OSC1 of the central unit CU and a second follower clock FC with a second local oscillator OSC2 of the respective sensor unit SU.

Herein, the start times and the subsequent time profile for the calculation of current phasors in the sensor unit SU are synchronized with times of the zero crossing of the fundamental-voltage oscillation.

This corresponds to time synchronization between the central unit CU and the sensor unit SU, i.e., coordination between the time base t_{EGS} of a leader timer or clock LC within the central unit CU with a corresponding follower time base t_{3NA} of an internal leader clock FC of the respective sensor unit SU.

This is not required to be an absolute time, but can refer to the individual fundamental-voltage oscillation periods and/or to the clock periods of the respective clocks LC, FC.

The sensor units SU each have an internal time unit FC, where these internal clocks serve as time units that generate a time base based on the numbered main voltage periods and/or in a time unit (t_{3NA}) on a microsecond basis.

The sensor units SU periodically capture sensor data SD in the form of current phasors with a specified time resolution of, for example, 1 microsecond, and/or provide it with a mains voltage period number and transmit it to the central unit CU via a radio network RL_L.

In the radio network or on the radio-frequency transmission path RF_L, an identification signal is transmitted at regular time intervals, for example, a SYNC frame MAC_SYNCF from the central unit CU to the respective sensor unit SU every two seconds. The reception of the identification signal SYNC frame MAC_SYNCF is monitored in a respective sensor unit SU.

Upon receipt of a characteristic time feature of the identification signal, a current value of the internal time unit FC of each respective sensor unit SU is stored with at least one transmitter identification contained in the identification signal, i.e., the data contained therein, such as the source address and/or authentication data from the RF module RF_M in the central unit CU, the characteristic time features contained therein, such as time stamps, time delay information, and/or number of the respective mains voltage period, and a current value of the time unit of the respective sensor unit SU, for example, from the received time stamp of the SYNC frame MAC_SYNCF.

Upon capture of sensor data SD, a further current value of the internal time unit FC of the respective sensor unit SU is stored; for example, a current time stamp of the time unit of each respective sensor unit SU and the number of the respective mains voltage period are assigned and stored with this sensor data SD.

The zero crossing is therefore synchronized to the local time unit in the sensor, where only the zero crossing in the sensor is to be reproduced as accurately as possible, and a reference to the time unit in the central unit is not necessary.

The captured sensor data SD is assigned at least the value of the internal time unit FC stored upon receipt of the characteristic time feature of the identification signal, the associated transmitter identification of the identification signal MAC_SYNCF, and the further value of the internal time unit stored when the sensor data SD is captured and transmitted together with the sensor data SD to the central unit CU.

This can occur via the data telegram sent by the respective sensor unit SU to the central unit CU; this contains the number of the mains voltage period to which the measurement data refers and the associated address of the central unit CU, i.e., as transmitter identification of the identification signal to which it is sent and a current time stamp of the time unit of the respective sensor unit SU, which is assigned upon data capture.

Based on the transmitter identification, a reference time base is derived and, based on the value of the internal time unit FC of the respective sensor unit SU stored upon receipt of the characteristic time feature of the identification signal and the further value of the internal time unit FC of the respective sensor unit SU stored upon capture of the sensor data SD, a temporal relationship of the transmitted sensor data SD of the respective sensor unit SU to the reference time base is derived, for example, based on the respective network period number from the received data telegram and/or the time stamp contained therein.

The central unit CU captures voltage and phase values from at least one of the three phase conductors of a power supply network from which synchronization data t0_{EGSp} and Tp for the frequency or period and for the phase angle of the voltage of at least one of the three phase conductors in relation to the time of capture of the voltage and phase values of the at least one of the three phase conductors is ascertained and transmitted to the sensor units SU.

The respective sensor unit SU captures the respective sensor data SD as current values in relation to synchronization data t0_{EGSp} and Tₚ, which are transmitted to the central unit CU.

In the central unit CU, powers, in particular active and reactive powers, are calculated from the voltage values and current values.

Synchronization data t0_{EGSp} relating to the phase angle of the voltage of at least one of the three phase conductors in relation to the time of capture of the voltage and phase values of the at least one of the three phase conductors are formed by the time of transmission of the SYNC frames MAC_SYNCF from the central unit CU to the respective sensor unit SU. Synchronization data t0_{EGSp}, Tₚ can be transmitted to the sensor units SU with the aid of the identification signal MAC_SYNCF.

Synchronization data t0_{EGSp}, Tₚ can be ascertained over more than one period of the voltage and phase values of the three phases of the power supply network, preferably from at least ten periods, particularly preferably from at least 100 periods.

The central unit CU can further capture voltage and phase values from a phase conductor of the power supply network and first supplementary synchronization data Δt_{EGSp-1} that was captured in a previous period preceding the current period in which synchronization data t0_{EGSp}, Tₚ is captured.

The first supplementary synchronization data Δt_{EGSp-1} can be transmitted to the respective sensor unit SU, preferably with the aid of the identification signal MAC_SYNCF.

The first supplementary synchronization data Δt_{EGSp-1} can be taken into account upon capture of the respective sensor data SD by the respective sensor unit SU.

In order to use the counter reading difference Δt_{EGSP-1}, it should be understood it is necessary for synchronization to occur periodically.

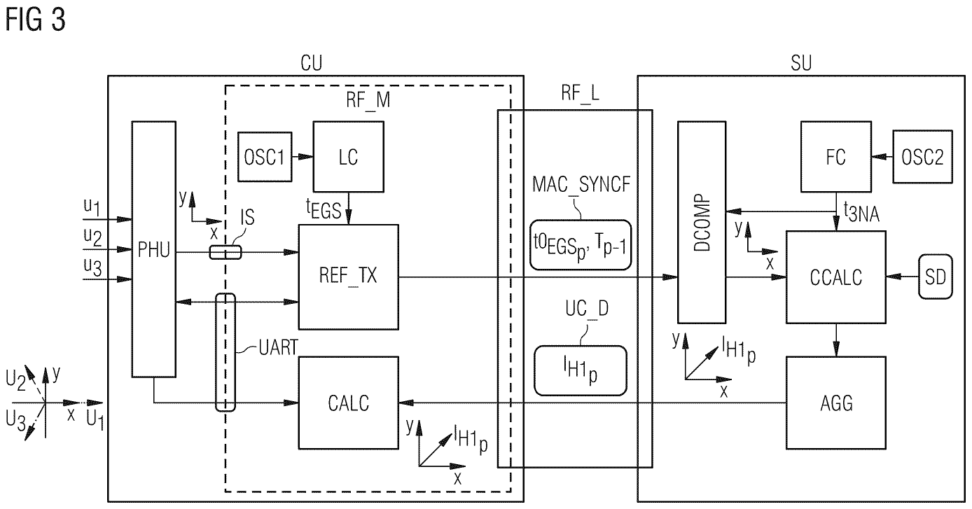

FIG. 3 shows a second block diagram of an exemplary embodiment of the invention.

In this exemplary embodiment, the information about the counter reading difference Δt_{EGSP-1} in the SYNC frame MAC_SYNCF of the measurement period p is not transmitted.

It is assumed that the transmission of the SYNC frames MAC_SYNCF in the central unit CU and, in particular in the transmitter REF_TX, occurs synchronously with the zero-point crossing time of the reference voltage U_{REF_H1} and only the runtime correction for the reception of the SYNC frame MAC_SYNCF occurs in the sensor unit SU to establish temporal synchronism between the central unit CU and the respective sensor units SU.

In this exemplary embodiment, upon transmission by the reference signal transmitter REF_TX of the central unit CU, a counter reading is transferred at which the transmission of the SYNC frames header MAC_SYNCF is to begin.

In contrast to the first exemplary embodiment, the time delay Δt_{EGSp} at the beginning of a measurement period p between the time t0_{EGSp} of activation of the interrupt signal IS, i.e., for the zero crossing of the reference voltage U_{REF_H1}, and the time t_{EGS_SYNCp} of the transmission of the synchronization frame MAC_SYNCF to the respective sensor unit SU is negligible and therefore does not need to be transmitted.

The synchronization frame MAC_SYNCF only transmits information about the period Tₚ₋₁, i.e., the estimated current voltage period, which was, for example, ascertained based on the last 10 to 30 voltage periods of the previous measurement period p−1.

The beginning of transmission of the SYNC frames MAC_SYNCF implicitly corresponds to the time t_{EGS_SYNCp}≈t0_{EGSp}, since the amount of the delay Δt_{EGSp} is usually negligible.

This means that, at the very beginning of the same measurement cycle p, compensation of the reception-side time delay of the SYNC frames MAC_SYNCF for the measurement period p and synchronization between the central unit CU and the respective sensor unit SU occurs.

The transmission of the SYNC frame MAC_SYNCF from the central unit CU is delayed by a fundamental oscillation period, exactly synchronized with the zero-point crossing time of the reference voltage U_{REF_H1}.

Upon transmission of the SYNC frames MAC_SYNCF, information about the time t0_{EGSp} is implicitly transmitted. In this example, no further counter reading of the central unit CU needs to be transmitted in the SYNC frame MAC_SYNCF.

The RF receiver unit in the sensor unit SU provides the counter reading at the time of reception of the SYNC frame header MAC_SYNCF.

Upon receipt of the SYNC frame MAC_SYNCF at time t0_{EGSp} of the respective sensor unit, the time t0_{EGSp}*=t0_{3NAp}.

In the present exemplary embodiment, the signal propagation time via the radio-frequency transmission path RF_L is corrected in the respective sensor unit SU by directly adopting the zero-point crossing time of the reference voltage U_{REF_H1} as the corrected time of reception of the SYNC frame header.

In this method, the zero-point crossing time of the reference voltage U_{REF_H1} can be ascertained from each SYNC frame MAC_SYNCF in the sensor unit SU.

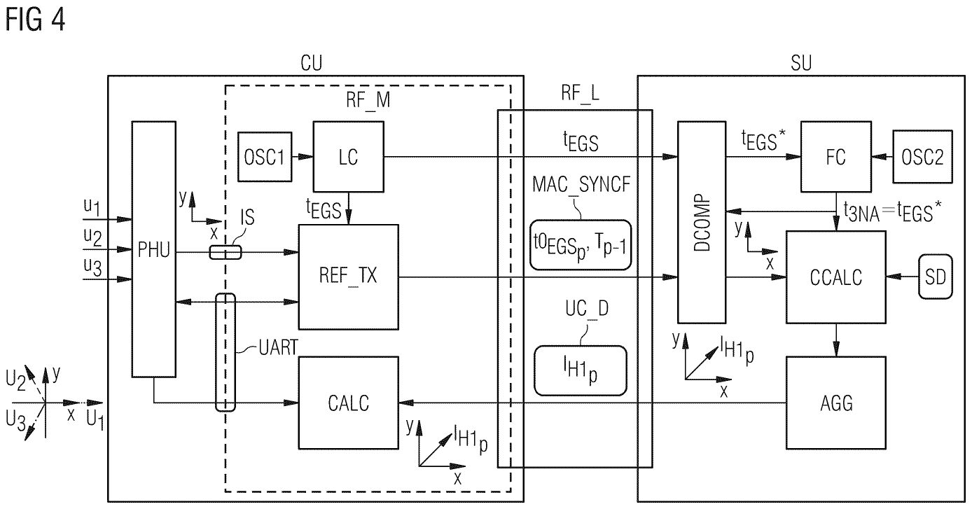

FIG. 4 shows a third exemplary embodiment of the invention in the form of a block diagram in which the time value t_{EGS} of the counter in the central unit CU is transmitted to the sensor unit SU via separate time synchronization frames and, after a runtime correction of the time base t_{3NA} in the sensor unit SU, is adopted by the value t_{EGS} of the time base of the central unit CU.

This correction of t_{3NA}=t_{EGS} is possible by preparing separate time synchronization frames in the central unit CU in advance and transmitting them to the sensor unit SU at the times contained in the frames.

This enables the central unit CU to send the above-described SYNC frames MAC_SYNCF at the start of each measurement period p not synchronously with the zero-point crossing time t0_{EGSp} of the reference voltage U_{REF_H1}, but within the first period of the reference voltage U_{REF_H1}, because the information about the zero-point crossing time is contained in the value t0_{EGSp} that refers to both the time t_{EGS} and the continuously synchronized time base t_{3NA} of the sensor unit SU.

This eliminates the need to transmit the time value of the transmission delay Δt_{EGSP-1} in the SYNC frame MAC_SYNCF and the time interval between the beginning of the measurement period p and the previous time reference point t0_{EGSp-1} from the first exemplary embodiment in FIG. 3 is shortened to the reference point t0_{EGSp}.

In other words, the central unit CU can further have an internal central time unit LC, the value of which forms second supplementary synchronization data t_{EGS}, and the second supplementary synchronization data can be transmitted to the respective sensor unit SU, preferably with the aid of the identification signal MAC_SYNCF, and the second supplementary synchronization data t_{EGS} can be taken into account upon capture of the respective sensor data SD by the respective sensor unit SU.

The current values of the respective sensor unit SU can be aggregated to form aggregated current phasors I_{H1p}, and the aggregated current phasors I_{H1p} can be transmitted to the central unit CU and, in the central unit CU, powers can be calculated from the voltage values and the aggregated current phasors I_{H1p}.

FIG. 5 shows a detailed view of the central unit CU of the invention.

All three of the aforementioned exemplary embodiments can be used if the central unit CU and at least one sensor unit SU communicate directly via a wired connection or via a plurality of nodes/hops, such as in an Ethernet-based “daisy chain”.

Herein, the runtime correction on the side of the respective sensor unit SU should occur upon receipt of the SYNC frame MAC_SYNCF depending on the position of the sensor unit SU in the daisy chain.

The runtime correction values are preferably determined for each sensor unit SU in a periodic runtime correction ascertainment or at the beginning of communication, i.e., for example, by the transmission of periodic runtime measurement frames.

An analog data capture apparatus AFE samples the voltages U2, U2, U3.

A zero-crossing detector ZCD detects zero crossings in the time profile of the reference voltage U_{REF_H1} and counts the voltage cycles of the respective voltage.

The radio-frequency module RF_M can, for example, be formed by a “Zigbee” module ZB_M and a “Zigbee” application ZB_APP, where the latter provides results RES for current, voltage and power.

A calculator CALC1 is used to calculate active power P and reactive power Q from corresponding voltages and currents, or from voltage phasors and current phasors.

A calculator CALC2 is used
to calculate voltage values from magnitude and phase information, wherein the enumeration point corresponds to the last previous enumeration point,
to provide the measurement periods of a reference voltage U_{REF_H1} counted in the zero-crossing detector ZCD,
to determine a reference line LREF of mains phase conductors L1, L2, L3 of the power supply network,
to determine a minimum voltage U_{MIN} below which the voltage zero-crossing points are not determined or counted in order to reduce error susceptibility,
to optionally determine a phase sequence of mains voltages u1, u2, u3 in the form of voltage phasors U1, U2, U3 of the mains voltage,
to determine voltage phasors U1, U2, U3 from the mains voltages u1, u2, u3.

The calculations of the calculator CALC2 are periodically checked over measurement cycles by a corresponding validation apparatus VAL, in particular with regard to the consistency of the voltage and current period numbering.

The data from the apparatus for reference phase transmission PHU is accordingly distributed to a radio-frequency module RF_M with the aid of the transmitter or receiver UART in the central unit CU.

An interrupt signal IS for zero crossing in the reference voltage U_{REF_H1} is provided to a reference signal transmitter REF_TX within the radio-frequency module RF_M, which in turn receives information regarding the zero crossing of the reference voltage tOEGS and a time delay upon transmission of sync frames MAC_SNCF Δt_{EGS} from a central oscillator OSC1 and a leader clock LC.

The minimum voltage U_{MIN} can ensure that only a minimum permissible voltage is taken into account in the subsequent evaluation for power calculation in order to reduce error susceptibility.

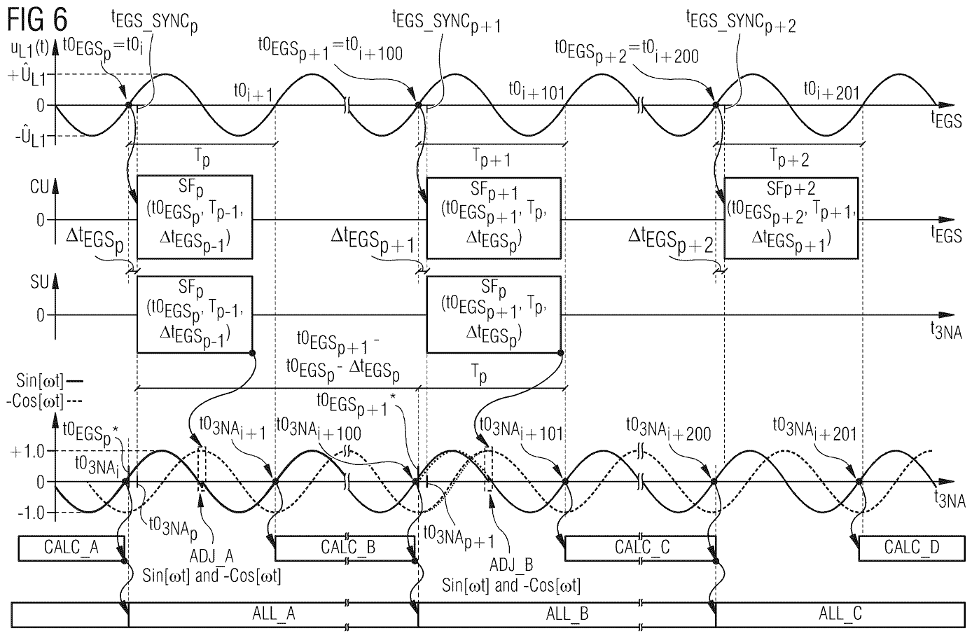

FIG. 6 shows an example of a signal profile in the power distribution network showing the temporal sequence of the data capture of the sensor data SD.

The time ranges ALL_A, ALL_B, ALL_C show the transmissions of all sensor units SU of the respective currents for the measurement periods p−1, p, p+1, p+2 to the central unit CU.

The time ranges CALC_A, CALC_B, CALC_C, CALC_D show the respective calculations of aggregated currents for the measurement periods p−1, p, p+1, p+2 in the sensor unit SU.

The time ranges ADJ_A, ADJ_B show the adjustments of time units of the respective sensor units SU from synchronization data of the respective SYNC frames SFₚ₋₁, SFₚ, SFₚ₊₁, SFₚ₊₂, which are generally referred to as a SYNC frame MAC_SYNCF.

The SYNC frame SFₚ₋₁ is not shown in the figure.

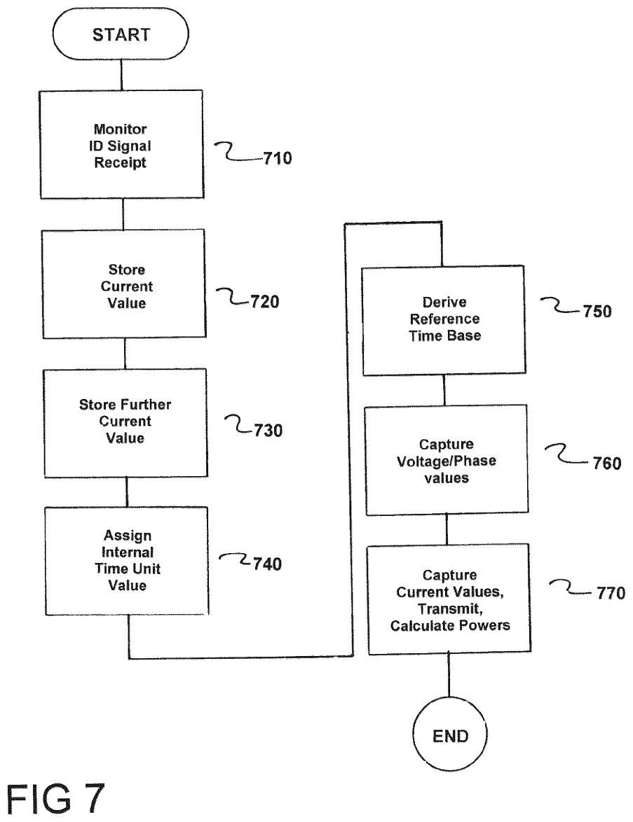

FIG. 7 is a flowchart of the method for time synchronization of sensor units SU in a distributed system, where the sensor units SU each respectively have an internal time unit FC, and sensor data SD is captured by the sensor units SU and transmitted to a central unit CU via a radio network, and an identification signal MAC_SYNCF is transmitted in the radio network at regular time intervals.

The method comprises monitoring reception of the identification signal MAC_SYNCF in a respective sensor unit SU, as indicated in step 710.

Next, a current value of the internal time unit FC of each respective sensor unit SU with at least one transmitter identification contained in the identification signal is stored upon receipt of a characteristic time feature of the identification signal MAC_SYNCF, as indicated in step 720.

Next, a further current value of the internal time unit FC of the respective sensor unit SU is stored upon capture of sensor data SD, as indicated in step 730.

Next, the captured sensor data SD is assigned at least a value of the internal time unit stored upon receipt of the characteristic time feature of the identification signal, the associated transmitter identification of the identification signal and the further value of the internal time unit FC stored upon capture of the sensor data SD and transmitted together with the sensor data SD to the central unit CU, as indicated in step 740.

Next, a reference time base is derived based on the transmitter identification and a temporal relationship of the transmitted sensor data SD of the respective sensor unit SU to the reference time base based on the value of the internal time unit FC of the respective sensor unit SU stored upon receipt of the characteristic time feature of the identification signal and the further value of the internal time unit FC of the respective sensor unit SU stored upon capture of the sensor data, as indicated in step 750.

Next, the central unit CU captures voltage and phase values of at least one of three phase conductors of a power supply network from which synchronization data t0_{EGSp}, Tₚ for a frequency or period and a phase angle of the voltage of at least one of the three phase conductors in relation to time of capture of the voltage and phase values of the at least one of the three phase conductors is ascertained and transmitted to the sensor units SU, as indicated in step 760.

Next, the respective sensor unit SU captures the respective sensor data SD as current values in relation to synchronization data t0_{EGSp}, Tₚ, the sensor data SD is transmitted to the central unit CU and, in the central unit CU, powers are calculated from the voltage values and current values, as indicated in step 770.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for time synchronization of sensor units in a distributed system, the sensor units each respectively having an internal time unit, and sensor data being captured by the sensor units and transmitted to a central unit via a radio network, and an identification signal being transmitted in the radio network at regular time intervals, the method comprising:
monitoring reception of the identification signal in a respective sensor unit;
storing a current value of the internal time unit of each respective sensor unit with at least one transmitter identification contained in the identification signal upon receipt of a characteristic time feature of the identification signal;
storing a further current value of the internal time unit of the respective sensor unit upon capture of sensor data;
assigning the captured sensor data at least a value of the internal time unit stored upon receipt of the characteristic time feature of the identification signal, the associated transmitter identification of the identification signal and the further value of the internal time unit stored upon capture of the sensor data and transmitted together with the sensor data to the central unit;
deriving a reference time base based on the transmitter identification and a temporal relationship of the transmitted sensor data of the respective sensor unit to the reference time base based on the value of the internal time unit of the respective sensor unit stored upon receipt of the characteristic time feature of the identification signal and the further value of the internal time unit of the respective sensor unit stored upon capture of the sensor data;
capturing, by the central unit, voltage and phase values of at least one of three phase conductors of a power supply network from which synchronization data for a frequency or period and a phase angle of the voltage of at least one of the three phase conductors in relation to time of capture of the voltage and phase values of the at least one of the three phase conductors is ascertained and transmitted to the sensor units; and
capturing, by the respective sensor unit, the respective sensor data as current values in relation to synchronization data, the sensor data being transmitted to the central unit and, in the central unit, powers being calculated from the voltage values and current values.

2. The method as claimed in claim 1, wherein synchronization data relating to the phase angle of the voltage of at least one of the three phase conductors in relation to the time of capture of the voltage and phase values of the at least one of the three phase conductors is formed by the time of transmission from the central unit to the respective sensor unit.

3. The method as claimed in claim 1, wherein synchronization data is transmitted to the sensor units aided by the identification signal.

4. The method as claimed in claim 1, wherein synchronization data is ascertained over more than one period of the voltage and phase values of the three phases of the power supply network.

5. The method as claimed in claim 1, wherein synchronization data is ascertained over at least ten periods of the voltage and phase values of the three phases of the power supply network.

6. The method as claimed in claim 5, wherein synchronization data is ascertained over at least 100 periods of the voltage and phase values of the three phases of the power supply network.

7. The method as claimed in claim 1, wherein the central unit captures voltage and phase values from a phase conductor of the power supply network and first supplementary synchronization data for the time delay in the transmission of the identification signal which was captured in a previous period prior to a current period in which synchronization data is captured and the first supplementary synchronization data is transmitted to the respective sensor unit aided by the identification signal, and the first supplementary synchronization data is taken into account upon capture of the respective sensor data by the respective sensor unit.

8. The method as claimed in claim 1, wherein the central unit further includes an internal central time unit, a value of which forms second supplementary synchronization data;
wherein the second supplementary synchronization data is transmitted to the respective sensor unit aided by the identification signal; and
wherein the second supplementary synchronization data is taken into account upon capture of the respective sensor data by the respective sensor unit.

9. The method as claimed in claim 1, wherein the current values of the respective sensor unit are aggregated to form aggregated current phasors;
wherein the aggregated current phasors are transmitted to the central unit;
wherein powers are calculated from the voltage values and the aggregated current phasors in the central unit.

10. A distributed system for time synchronization of sensor units, the distributed system comprising:
a central unit; and
memory;
wherein the distributed system is configured to:
monitor reception of the identification signal in a respective sensor unit;
store a current value of the internal time unit of each respective sensor unit with at least one transmitter identification contained in the identification signal upon receipt of a characteristic time feature of the identification signal;
store a further current value of the internal time unit of the respective sensor unit upon capture of sensor data;
assign the captured sensor data at least a value of the internal time unit stored upon receipt of the characteristic time feature of the identification signal, the associated transmitter identification of the identification signal and the further value of the internal time unit stored upon capture of the sensor data and transmitted together with the sensor data to the central unit;
derive a reference time base based on the transmitter identification and a temporal relationship of the transmitted sensor data of the respective sensor unit to the reference time base based on the value of the internal time unit of the respective sensor unit stored upon receipt of the characteristic time feature of the identification signal and the further value of the internal time unit of the respective sensor unit stored upon capture of the sensor data;
capture, by the central unit, voltage and phase values of at least one of three phase conductors of a power supply network from which synchronization data for a frequency or period and a phase angle of the voltage of at least one of the three phase conductors in relation to time of capture of the voltage and phase values of the at least one of the three phase conductors is ascertained and transmitted to the sensor units; and
capture, by the respective sensor unit, the respective sensor data as current values in relation to synchronization data, the sensor data being transmitted to the central unit and, in the central unit, powers being calculated from the voltage values and current values.
